(19) United States
(12) Patent Application Publication
(10) Pub. No.: US 2026/0295899 A1
(43) Pub. Date: Oct. 1, 2026

(54) TURNING DEVICE AND METHOD FOR TURNING AND PRODUCING A WALL ELEMENT

(71) Applicant: EBAWE Anlagentechnik GmbH, Eilenburg (DE)

(72) Inventor: Marcus SCHELER, Eilenburg (DE)

(21) Appl. No.: 19/570,905

(22) Filed: Mar. 18, 2026

(30) Foreign Application Priority Data
Mar. 27, 2025 (EP) 25166762

(51) Int. Cl. B28B 7/08; B28B 7/00

(52) U.S. Cl. CPC B28B 7/082; B28B 7/002; B28B 7/085

(57) ABSTRACT

A turning device is provided for turning a wall element, preferably of a precast concrete double wall. The turning device includes a pallet configured for supporting and turning the wall element, and a support device designed to support the wall element at at least one edge of the wall element during turning to prevent the wall element from slipping on the pallet. The support device is designed to move toward the edge of the wall element in order to support the wall element.

### BACKGROUND OF THE INVENTION

The present invention relates to a turning device for turning a wall element, preferably of a precast concrete double wall, wherein the turning device comprises a pallet designed for carrying and turning the wall element and a support device designed to support the wall element against slipping of the wall element on the pallet at at least one edge of the wall element when turning. Furthermore, the invention relates to a method for turning a wall element and a method for producing a precast concrete double wall, also called a sandwich wall.

Such turning devices are used in the construction industry to manufacture, process or change the orientation of large components such as walls or slabs. The wall element is usually placed on the pallet, along with which it is rotated by a desired angle, e.g. 180°. In many cases, it is important that the turning element remains in a predefined or desired position on the palette before, during, and after turning, without it shifting or slipping relative to the palette.

In known prior art devices, the wall element is supported at a foot or turning edge or at an edge formwork element, thereby limiting the slippage of the wall element relative to the pallet. However, slippage is not completely ruled out with these devices, as the wall element can still slide along the pallet until it rests against the support device. This can cause damage to the wall element. In some cases, it may happen that the wall element can only be passed on or placed in an inaccurate alignment.

### SUMMARY OF THE INVENTION

The object of the present invention is therefore to provide a turning device improved upon the prior art, which completely prevents the wall element from slipping and thus keeps the wall element in a predefined position on the pallet.

This object is achieved by a turning device of the type mentioned at the outset, in which the support device is designed to move to the edge of the wall element in order to support the wall element.

A first major advantage of the invention is that the wall element, such as the first shell of a precast concrete double wall, also called a sandwich wall, never slides along the pallet. This prevents damage to the pallet or the wall element, especially to the surface of the wall element resting on the pallet or to the edge of the wall element around which the wall element is tilted. This allows for the production of higher quality wall elements.

Another advantage is that it allows for precise positioning of the wall element relative to the pallet. Subsequently, the turned wall element can be precisely aligned with the pallet and passed on to another device, e.g. for post-processing, or placed precisely on another wall element to produce a precast concrete double wall.

An associated advantage is that the wall element can be passed on or placed down immediately after turning it over on the pallet.

These advantages are particularly relevant in the production of precast concrete double walls or sandwich walls, as their production can be carried out faster and with fewer devices using the turning device, and the quality of the precast concrete double walls can be increased.

A wall element is preferably a concrete slab, in particular a first shell of a precast concrete double wall, also called a sandwich wall, which may be reinforced, contain further components such as spacers and/or on which an insulation layer or other layers may be applied.

The wall element preferably comprises a concrete slab and/or an insulation layer of a precast concrete double wall, wherein a precast concrete double wall preferably comprises a first wall element and a second wall element with an insulation layer arranged between them. The wall element can also be a panel, e.g. a ceiling. The wall element can include concrete, reinforcing steel, wood, metal and/or insulation materials. The wall element may have cutouts, e.g. for window or door openings.

The aforementioned advantages are particularly evident when, in the production of precast concrete double walls, the wall element, especially the first shell, is formed using at least one formwork element that can be magnetically attached to the pallet, by pouring the concrete into the wall element. The formwork element, which can be magnetically attached to the pallet, cannot transmit or absorb transverse forces, i.e., forces that act parallel to the surface of the pallet. The support device is then able to absorb the transverse forces acting on at least one formwork element.

Alternatively, at least one formwork element can be detached and removed from the pallet before turning, and the support device can be moved up to abutment against the wall element. The at least one edge of the wall element preferably limits the wall element in a plane parallel to a median plane of the wall element. The at least one edge of the wall element is preferably located on side surfaces of the wall element which are oriented orthogonally to the central plane of the wall element.

The turning device can be designed to turn multiple wall elements, preferably simultaneously. The pallet is preferably designed in such a way that the wall element can lie flat on the pallet. The wall element can rest on the pallet in a predefined or desired position. Preferably, the pallet has a closed surface. It is also conceivable that the turning device comprises multiple pallets.

The support device is designed to move towards the edge of the wall element, i.e., in particular, to move towards the edge of the wall element, wherein direct contact between the support device and the edge of the wall element is not necessarily required. There can be direct contact between the support device and the edge of the wall element, so that when turning, a direct force transmission between the edge of the wall element and the support device is possible.

There can be at least one element, in particular a formwork element, arranged between the support device and the edge of the wall element, so that when turning, an indirect force transmission between the edge of the wall element and the support device is possible via the at least one element.

It is particularly preferred that the support device is designed to move away from the edge of the wall element in order to release the wall element, in particular so that a distance is created between the support device and the wall element. For example, this makes it possible to move the pallet with the wall element away from the support device and, if applicable, from a turning frame without collisions with the support device, in particular so that the wall element is not moved along the pallet.

In particularly preferred embodiments, the turning device comprises at least one formwork element attached to the pallet, which is designed to at least partially delimit the edge of the wall element. This makes it possible to produce the wall element directly on the pallet using formwork with the at least one formwork element and by pouring concrete.

Preferably, at least one formwork element is detachably, and especially preferably magnetically, attached to the pallet. This allows at least one formwork element to be positioned variably on the pallet in order to produce wall elements with different outer contours. It is particularly preferred that the at least one formwork element can be arranged at least in sections between the support device and the at least one edge of the wall element, wherein the support device is designed to support the at least one formwork element and the wall element against slippage of the at least one formwork element and the wall element on the pallet. This allows the wall element to be turned over together with the at least one formwork element. In other words, the support device indirectly supports the wall element during turning via the at least one formwork element, while the at least one formwork element is directly supported by the support device.

The wall element can also be turned over without the at least one formwork element, e.g. if the formwork is removed before turning. The support device is preferably designed to support either the at least one formwork element and the wall element together, or only the wall element, against slipping during turning. If the turning device comprises at least one formwork element that is detachably and magnetically attached to the pallet, the turning device according to the invention is particularly advantageous, since such formwork elements are not well able to withstand shear stress, i.e. in the direction parallel to the surface of the pallet, and the turning device can support the wall element stably and securely during turning, with or without such formwork elements.

Preferably, the support device, in a holding position brought close to the wall element, rests against the at least one formwork element or can be placed against the edge of the wall element to support the wall element. This allows for a direct load transfer from the wall element to the support device.

Preferably, the support device is spaced away from the at least one formwork element in a release position moved away from the wall element, or can be positioned spaced away from the wall element, wherein the wall element and/or the at least one formwork element can be removed from the pallet.

In particularly preferred embodiments, the support device is movable translationally, preferably parallel to a surface of the pallet. The travel distance or the distance between the holding position and the release position of the support device can be, for example, 10-20 mm. Preferably, the turning device has at least one drive for moving the support device. The drive can be, for example, a hydraulic, pneumatic, or electric drive.

The support device particularly preferably has multiple drives, preferably operable synchronously, for moving the support device. In preferred exemplary embodiments, the support device has at least one contact surface oriented orthogonally to the surface of the pallet, which can be applied to the edge of the wall element or to the at least one formwork element in a force-transmitting manner. This allows for safe and stable support. The at least one contact surface can consist of one or more surfaces. For example, the contact surface can be a single strip-shaped surface, comprise multiple circular sub-surfaces, etc.

In particularly preferred exemplary embodiments, the support device comprises at least one, in particular rigid, beam which is designed to support at least one edge of the wall element. Such a beam enables uniform support of the at least one edge of the wall element without deforming as a result of the loads of the wall element. Preferably, the at least one beam extends, in particular continuously, over a length of the at least one formwork element. This allows the wall element to be supported evenly along the entire length of one of its edges, for example. In particularly preferred embodiments, the support device comprises multiple drives for moving the at least one beam.

Preferably, the turning device comprises a turning frame, wherein the turning frame is rotatably mounted and wherein the pallet is preferably detachably attached to the turning frame, and wherein the wall element can be arranged on the pallet. By designing the turning frame and the pallet separately, versatile use of the pallet is possible, for example, even independently of a turning device. Furthermore, different types of pallets can be used in the reversible frame. Preferably, the pallet is designed with a closed surface, in particular so that it represents a formwork component for the production of a concrete wall element.

In particularly preferred embodiments, the turning device comprises at least one hold-down means designed to hold the wall element down on the pallet. Preferably, the at least one hold-down means is designed to hold the wall element down on the pallet in a direction perpendicular to the surface of the pallet. Preferably, the at least one holding means is pivotable and/or extendable away for releasing the wall element from the pallet.

In particularly preferred embodiments, the support device is designed separately from the at least one hold-down means. Preferably, the support device and the at least one hold-down means are arranged in two different planes parallel to the top of the pallet. Due to the separate design, the at least one hold-down means and the support device can each be used only when needed.

It is also conceivable that the support device and the at least one hold-down means are combined, wherein when the wall element is turned over they jointly have a hold-down function and a support function preventing the wall element from slipping on the pallet. This type of implementation can be practical in certain use cases.

It is possible that the support device is designed to exert a holding force on the edge of the wall element, so that the wall element is arranged immovably on the pallet. For example, the support device can be designed to clamp the wall element. This allows the wall element to be held even more stably in the predefined position. In particularly preferred embodiments, the turning device has a drive device for rotating the pallet, preferably the turning frame. The drive device can be, for example, a hydraulic, pneumatic, or electric drive device.

Protection is also sought for a method for turning a wall element with a turning device according to the invention, comprising the following steps:
providing the wall element on the pallet;
moving the at least one support device to the edge of the wall element or to the at least one formwork element; and
rotating the palette.
Preferably, the pallet is aligned horizontally to a ground before being turned over, so that the wall element is also initially aligned horizontally. Preferably, the pallet is rotated by at least 90°, particularly preferably by 180°.

In preferred embodiments, the method additionally comprises the following steps:
laying down the wall element, preferably rotated by 180°;
moving the at least one support device away from the wall element or the at least one formwork element.
Preferably, the wall element is placed on another wall element, wherein the turning device according to the invention makes it possible to align the wall element precisely on the other wall element.

Furthermore, protection is sought for a method for producing a precast concrete double wall with a turning device according to the invention and a method according to the invention for turning a wall element:
wherein the wall element is provided by pouring concrete in at least one formwork element, preferably detachably, particularly preferably magnetically, attached to the pallet, and applying an insulation layer, and preferably hardening them together, and
wherein the wall element, after being rotated with the pallet, is placed on another wall element with the insulation layer, so that the insulation layer is arranged between the wall element and the other wall element.

Preferably:
at least part of the insulation layer is removed before the pallet is rotated, and
the at least one hold-down means engages at least one surface of the wall element thereby exposed on the wall element and holds the wall element down on the pallet, and
the at least one removed part is added back to the insulation layer, e.g. glued in, after the wall element has been laid down.

### BRIEF DESCRIPTION OF THE DRAWINGS

Further advantages and details of advantageous variants of the invention will be apparent from the following description with reference to the drawings, in which:

FIGS. 1-9 are views, sections and details of a preferred exemplary embodiment of a turning device according to the invention and

FIGS. 10-18 show a preferred variant of the inventive method for producing a precast concrete double wall using the turning device according to the invention.

### DETAILED DESCRIPTION OF THE INVENTION

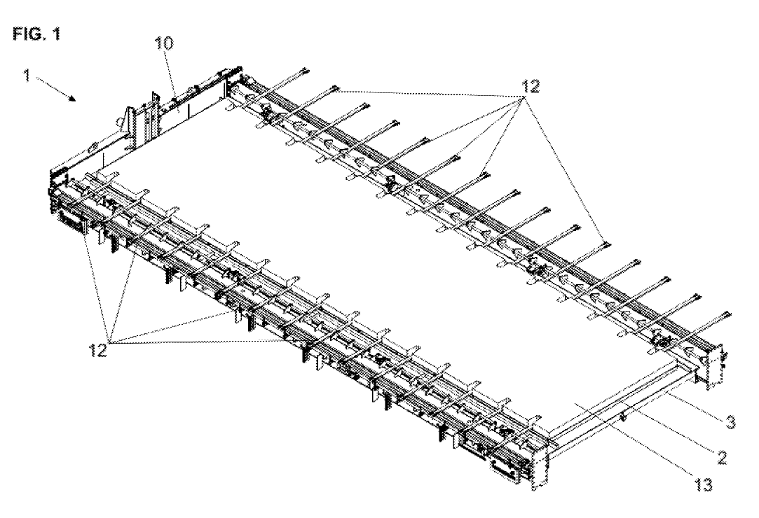

FIG. 1 shows a perspective view of a preferred exemplary embodiment of a turning device 1 according to the invention, in which the turning device 1 comprises a turning frame 10 and a pallet 3, wherein the turning frame 10 is rotatably mounted and wherein the pallet 3 is fastened to the turning frame 10, preferably detachably. A wall element 2 with an insulation layer 13 arranged above it is placed on pallet 3. This exemplary embodiment comprises multiple hold-down means 12 which are designed to hold down the wall element 2 on the pallet 3.

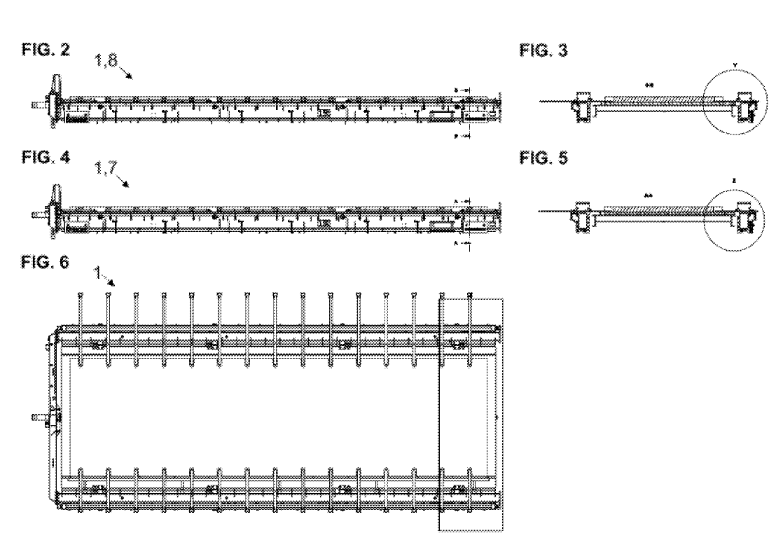

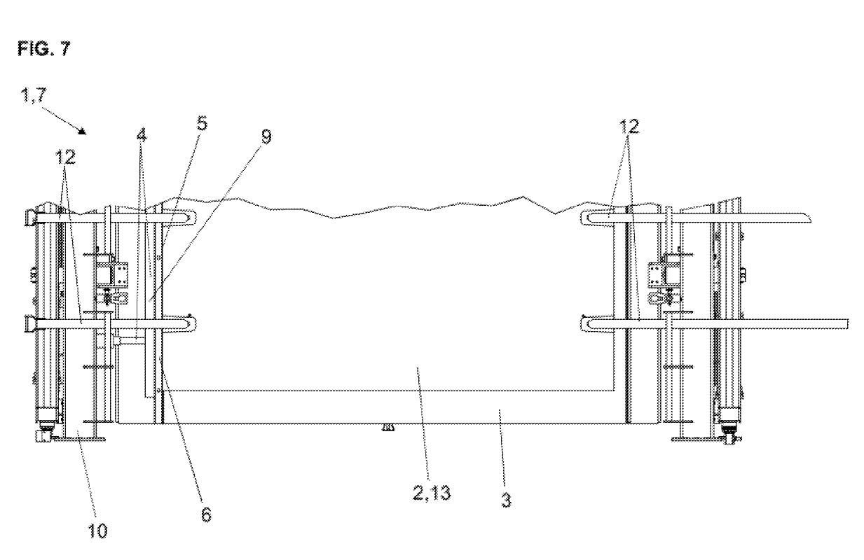

FIGS. 2-6 show, without reference numerals, views and details of the preferred exemplary embodiment for overview purposes, with all related details and sections described with reference numerals in the following FIGS. 7-9.

Thus, FIG. 7 shows the section shown in the top view of FIG. 6, which has been rotated by 90° compared to FIG. 6.

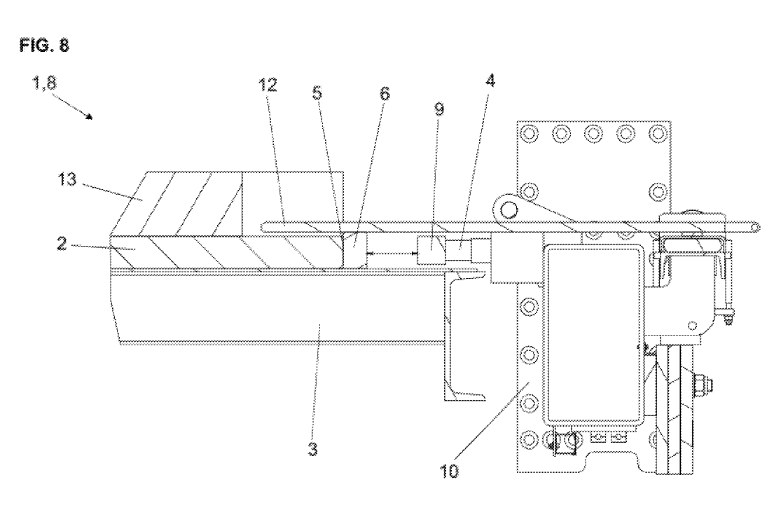

FIG. 2 shows a side view of the preferred exemplary embodiment of the turning device 1 in a release position 8; FIG. 3 shows the associated section B-B; and FIG. 8 shows the detail of section B-B of FIG. 3.

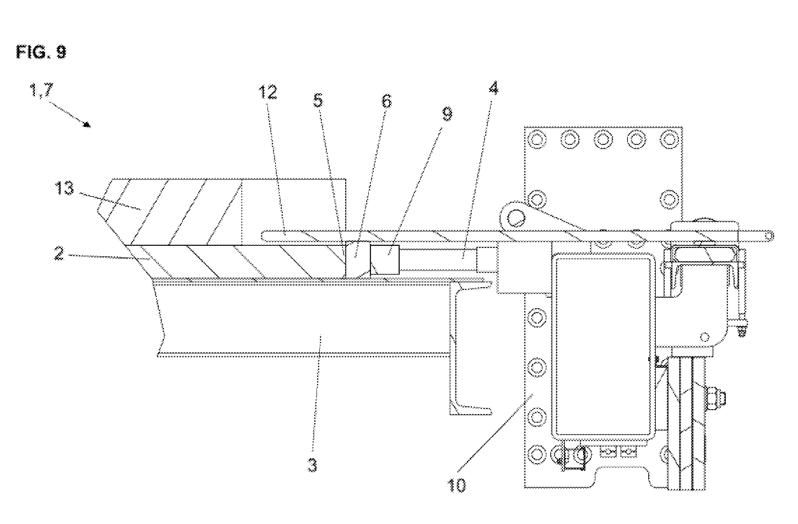

FIG. 4 shows a side view of the preferred exemplary embodiment of the turning device 1 in a holding position 7; FIG. 5 shows the associated section A-A; and FIG. 9 shows the detail of section A-A of FIG. 5.

FIG. 7 thus shows a section of a top view of the preferred exemplary embodiment of a turning device 1 according to the invention for turning a wall element 2, preferably of a precast concrete double wall, wherein the turning device 1 comprises:
a pallet 3, which is designed to carry and turn the wall element 2, and
a support device 4, which is designed to support the wall element 2 against slippage of the wall element 2 on the pallet 3 when turning it at at least one edge 5 of the wall element 2.

The support device 4 is designed to move to the edge 5 of the wall element 2 in order to support the wall element 2.

In this exemplary embodiment, the turning device 1 has at least one formwork element 6, which is preferably detachably and particularly preferably magnetically attached to pallet 3, which is designed to delimit at least in sections the edge 5 of wall element 2 and which can be arranged at least in sections between the support device 4 and the at least one edge 5 of the wall element 2, wherein the support device 4 is designed to support the at least one formwork element 6 and the wall element 2 against slipping of the at least one formwork element 6 and the wall element 2 on the pallet 3. In the position of the turning device 1 shown in FIG. 7, the support device 4 is in a holding position 7 moved to the wall element 2, wherein it rests against the at least one formwork element 6 to support the wall element 2. In this exemplary embodiment, the support device 4 comprises at least one beam 9, which is designed to support the wall element 5 and the at least one formwork element 6.

FIG. 8 shows a detail from section B-B through the turning device 1 shown in FIG. 3. Here it can be clearly seen that the support device 4 is preferably designed to move away from the edge 5 of the wall element 2 in order to release the wall element 2. Preferably, the support device 4 can be positioned at a distance from the at least one formwork element 6 in a release position 8 moved away from the wall element 2, such that the wall element 2 and/or the at least one formwork element 4 can be or are removed from the pallet 3, as soon as the at least one hold-down element 12 has been rotated away.

In FIG. 8, it can also be clearly seen that the support device 4 in this preferred exemplary embodiment is designed separately from the at least one hold-down means 12. Preferably, the support device 4 and the at least one hold-down means 12 are arranged in two different planes parallel to the top of the pallet 3.

FIG. 9 shows a detail from section A-A through the turning device 1 shown in FIG. 5. When compared with FIG. 8, it can be clearly seen that the support device 4 is movable, preferably translationally, and particularly preferably parallel to a surface of the pallet 3.

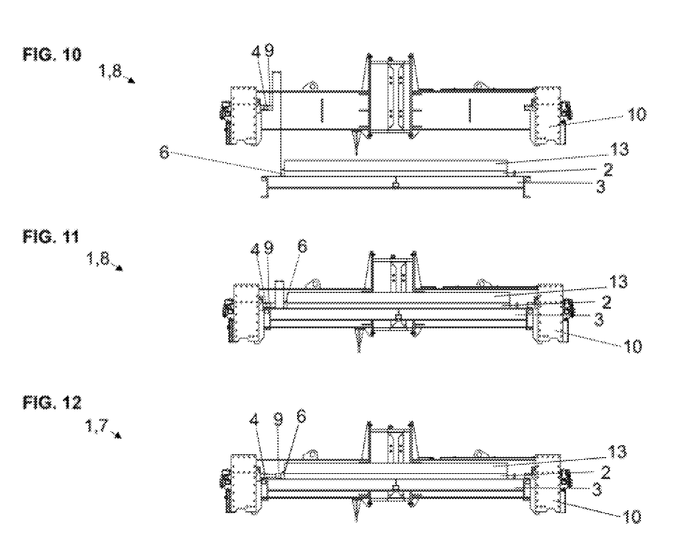

FIGS. 10-18 show a preferred variant of the inventive method for producing a precast concrete double wall, which includes the preferred method steps for turning the wall element 2.

In FIG. 10, a wall element 2 has been already provided on the pallet 3, and the wall element 2 is preferably produced by pouring concrete in at least one formwork element 6, preferably detachably, particularly preferably magnetically, attached to the pallet 3, and by applying an insulation layer 13 thereon, and preferably hardening them together. Preferably, the at least one formwork element 6, which may be reinforced and/or equipped with spacers, for example, is filled with concrete, wherein the insulation layer 13 is applied to the concreted wall element 2 before the concrete dries, so that the insulation layer 13 bonds with the surface of the wall element 2. Then the concrete hardens.

From FIGS. 10 - 11, the turning frame 10 was moved towards the pallet 3 and the wall element 2 lying on it with the connected insulation layer 13, and the pallet 3 was attached to the turning frame 10, with the support device 4 being in a retracted release position 8. In FIG. 11, the pallet 3 is attached to the turning frame 10 and the support device 4, in particular the beam 9, is moved towards the at least one formwork element 6 until the support device 4 is in the holding position 7 shown in FIG. 12.

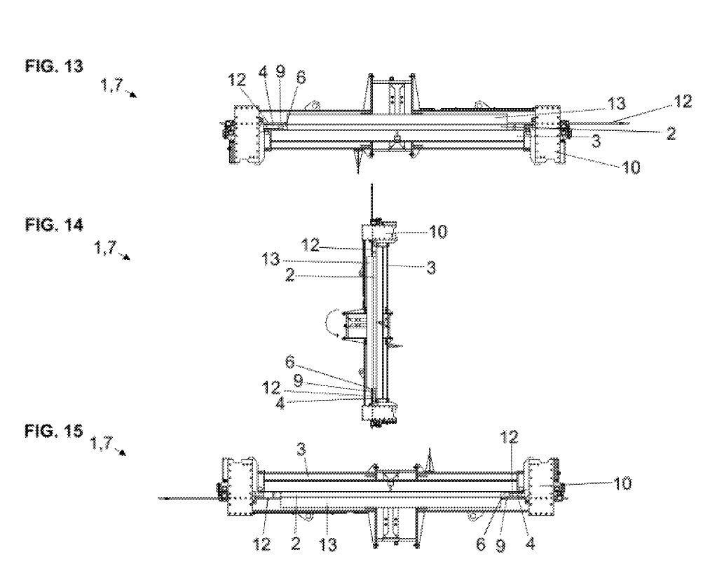

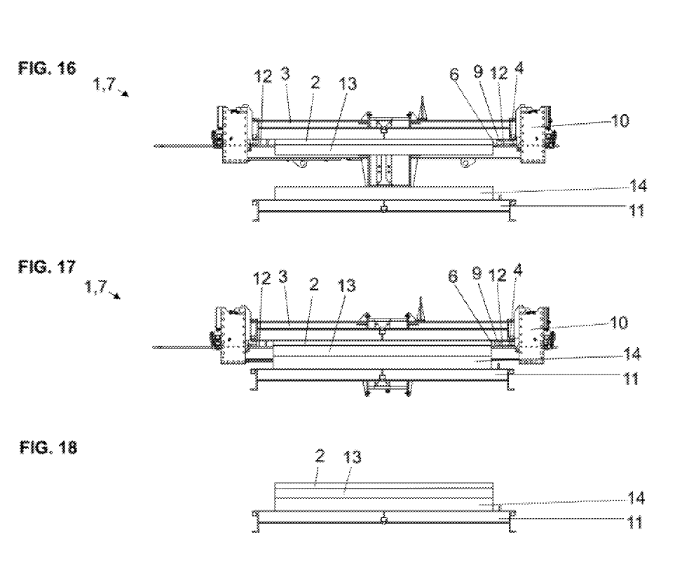

In FIG. 13, at least a part was removed from the insulation layer 13 and at least one hold-down means 12 engages at least one surface of the wall element 2 thereby exposed on the wall element 2 and holds the wall element 2 down on the pallet 3. In FIG. 14, the pallet 3 with the wall element 2, including the insulation layer 13, which is securely held on the pallet 3, is rotated. In FIG. 15, the wall element 2 including the insulation layer 13 was rotated by 180° so that the insulation layer 13 is now at the bottom. In FIG. 16, the rotated wall element 2 is moved by the pallet 3 towards another wall element 14 arranged on another pallet 11. In FIG. 17, the wall element 2 is precisely placed on the other wall element 14 with the insulation layer 13, so that the insulation layer 13 is arranged between the wall element 2 and the other wall element 14. This further wall element 14 is preferably also made of concrete and preferably equipped with reinforcement and/or spacers.

At the time of placing the wall element 2 with the insulation layer 13 onto the further wall element 14, the further wall element 14 is preferably not yet hardened, so that the insulation layer 13 can bond with the further wall element 14. Preferably, the insulation layer 13 connected to the wall element 2 is immersed in the further wall element 14, also called second shell, which has been freshly concreted using the further pallet 11.

In the state shown in FIG. 17, in which the wall element 2 with the insulation layer 13 is connected to the further wall element 14 to form a unit, this unit can be set in motion and compacted. This allows the liquid concrete to be deaerated. This also allows any elements protruding from wall element 2, such as reinforcement components or thermopins, to bond better with the liquid concrete of the further wall element 14. After precise placement and, if necessary, compaction, the support device 4 moves away from the at least one formwork element 6 again into the release position 8.

In FIG. 18, the support device 4 and the pallet 3 have been completely moved away, whereupon the at least one part removed from the insulation layer 13 is added back to the insulation layer 13, e.g. glued in. The precast concrete double wall is now finished and is ready on the next pallet 11.

1. A turning device for turning a wall element, preferably of a precast concrete double wall, the turning device comprising:
a pallet, which is configured for supporting and turning the wall element, and
a support device designed to support the wall element at at least one edge of the wall element during turning to prevent the wall element from slipping on the pallet,
wherein the support device is designed to move toward the edge of the wall element in order to support the wall element.

2. The turning device according to claim 1, wherein the support device is designed to move away from the edge of the wall element to release the wall element.

3. The turning device according to claim 1, further comprising at least one formwork element attached to the pallet, preferably detachably, particularly preferably magnetically, which is designed to at least partially delimit the edge of the wall element.

4. The turning device according to claim 3, wherein the at least one formwork element can be arranged at least in sections between the support device and the at least one edge of the wall element, wherein the support device is designed to support the at least one formwork element and the wall element against slipping of the at least one formwork element and the wall element on the pallet.

5. The turning device according to claim 1, wherein the support device rests against the at least one formwork element or can be placed against the edge of the wall element in a holding position moved up against the wall element for supporting the wall element.

6. The turning device according to claim 1, wherein the support device can be positioned at a distance from the at least one formwork element or at a distance from the wall element in a release position moved away from the wall element, wherein the wall element and/or the at least one formwork element can be removed from the pallet.

7. The turning device according to claim 1, wherein the support device is movable translationally, preferably parallel to a surface of the pallet.

8. The turning device according to claim 1, wherein the support device comprises at least one beam which is designed to support the at least one edge of the wall element and/or the formwork element.

9. The turning device according to claim 1, wherein the turning device comprises a turning frame, wherein the turning frame is rotatably mounted and wherein the pallet is preferably detachably attached to the turning frame, and wherein the wall element can be arranged on the pallet.

10. The turning device according to claim 1, wherein the turning device comprises at least one hold-down means which is designed to hold the wall element down on the pallet.

11. The turning device according to claim 10, wherein the support device is designed separately from the at least one hold-down means, preferably wherein the support device and the at least one hold-down means are arranged in two different planes parallel to the top of the pallet.

12. A method for turning a wall element with a turning device according to claim 1, the method comprising:
providing the wall element on the pallet;
moving the at least one support device to the edge of the wall element or to the at least one formwork element; and
rotating the pallet, preferably by 180°.

13. The method according to claim 12, further comprising:
laying down the wall element, preferably rotated by 180°;
moving the at least one support device away from the wall element or the at least one formwork element.

14. A method for producing a precast concrete double wall using the method according to claim 13,
wherein the wall element is provided by pouring concrete in at least one formwork element, preferably detachably, particularly preferably magnetically, attached to the pallet, and applying an insulation layer, and preferably hardening them together, and
wherein the wall element, after being rotated with the pallet, is placed on another wall element with the insulation layer, so that the insulation layer is arranged between the wall element and the other wall element.

15. The method according to claim 14,
wherein at least part of the insulation layer is removed before the pallet is rotated and
wherein at least one hold-down means engages at least one surface of the wall element thereby exposed on the wall element and holds the wall element down on the pallet and
wherein the at least one removed part is added back to the insulation layer, after the wall element has been laid down.
